(19) United States
(12) Patent Application Publication
(10) Pub. No.: US 2004/0264726 A1
(43) Pub. Date: Dec. 30, 2004

(54) Microphoning

(76) Inventors: Daniel M. Gauger JR., Cambridge, MA (US); Clifford A. Henricksen, Framingham, MA (US); Kenneth Dylan Jacob, Framingham, MA (US); Roman Sapiejewski, Boston, MA (US); Anthony J. Sarno, Hopkinton, MA (US); Michael H. Thomas, Framingham, MA (US)

Correspondence Address: FISH & RICHARDSON PC, 225 FRANKLIN ST, BOSTON, MA, 02110, US

(21) Appl. No.: 10/610,464

(22) Filed: Jun. 30, 2003

(51) Int. Cl. H04R 9/08; H04R 11/04; H04R 17/02; H04R 19/04; H04R 21/02

(52) U.S. Cl. 381/369; 381/355; 381/359; 381/361

(57) ABSTRACT

A microphone has first and second differentially interconnected capsules angularly and linearly displaced from each other by a predetermined amount.

The present invention relates in general to microphoning and more particularly concerns a novel differentially combined two-capsule microphone.

### BACKGROUND OF THE INVENTION

For background reference is made to the Microphone Handbook, pp. 81-82.

It is an important object of the invention to provide an improved differentially combined dual-capsule microphone.

### SUMMARY OF THE INVENTION

A microphone according to the invention comprises differentially-combined first and second angularly and linearly displaced capsules. An advantage of the invention is reduced temporal and spectral distortion and higher gain before feedback.

In one form there is a hand-held version especially suitable for vocalists, preferably constructed and arranged to fit the hand and upon standard microphone clips that in turn fit on standard microphone stands and hardware. In another form there is a stand-mount version for vocalists and instrumentalists with the acoustical element permanently attached to a microphone clip that fits standard microphone stands and hardware. In another form there is a clamp-clip embodiment constructed and arranged for attachment to musical instruments, such as wind instruments and drums. The acoustical element for the clamp-clip embodiment is typically the same as for the stand-mount version except with a microphone cable, typically about eight meters long, permanently attached to the assembly and terminating in a standard male XLR connector.

In a specific form the spacing between capsules is greater than ½″. Preferably there is a puff filter on one or both capsules with the distance between puff filter and capsule being less than about ⅛″, an advantageous puff filter being disclosed in U.S. Pat. No. 4,975,966.

According to an aspect of the invention, the two differentially combined capsules are constructed and arranged with variable spacing between the capsules, typically within a range of ½″ to 5″.

Other features, objects and advantages of the invention will become apparent from the following detailed description when read in connection with accompany drawing in which:

### BRIEF DESCRIPTION OF THE SEVERAL VIEWS OF THE DRAWING

FIG. 1 is a pictorial representation of an embodiment of the invention;

FIG. 2 is a schematic circuit diagram showing the differential combination of the transduced signals from the dual capsules;

FIG. 3 is a simplified schematic of the microphone system;

FIG. 4 shows a suitable stand with a boom and extendable shaft;

FIG. 5 shows a flexible support;

FIG. 6 shows a clip mount;

FIG. 7 shows a hand-held arrangement;

FIG. 8 is a perspective view of an actual handheld embodiment of the invention;

FIG. 9 is a perspective view of an actual stand-mount embodiment of the invention;

FIGS. 10A and 10B are perspective views of actual clamp mount embodiments of the invention suitable for mounting on drums and brass instruments;

FIG. 11A showing the embodiment of FIGS. 10A and 10B mounted on the rim of a drum;

FIG. 11B is a pictorial representation showing how the embodiment of FIGS. 10A and 10B may be mounted on the bell of a wind instrument;

FIG. 12A is a side view of the embodiment shown in FIGS. 11A and 11B in the clamped position; and

FIG. 12B is a side view of the embodiment shown in FIGS. 11A and 11B in the unclamped position.

### DETAILED DESCRIPTION

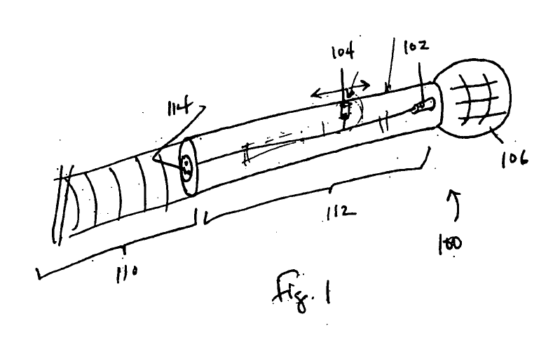

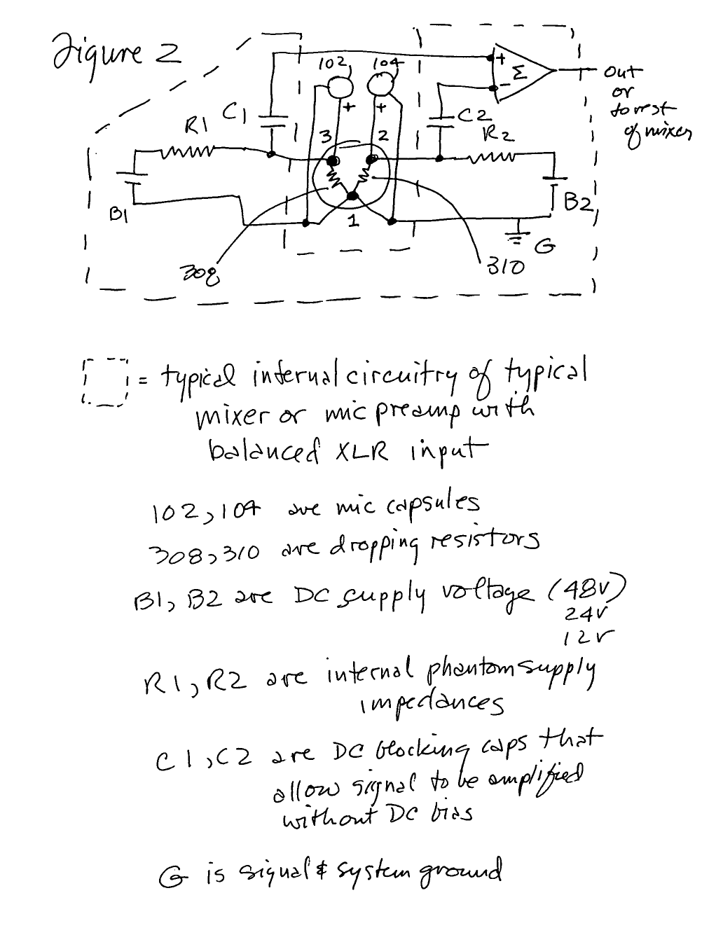

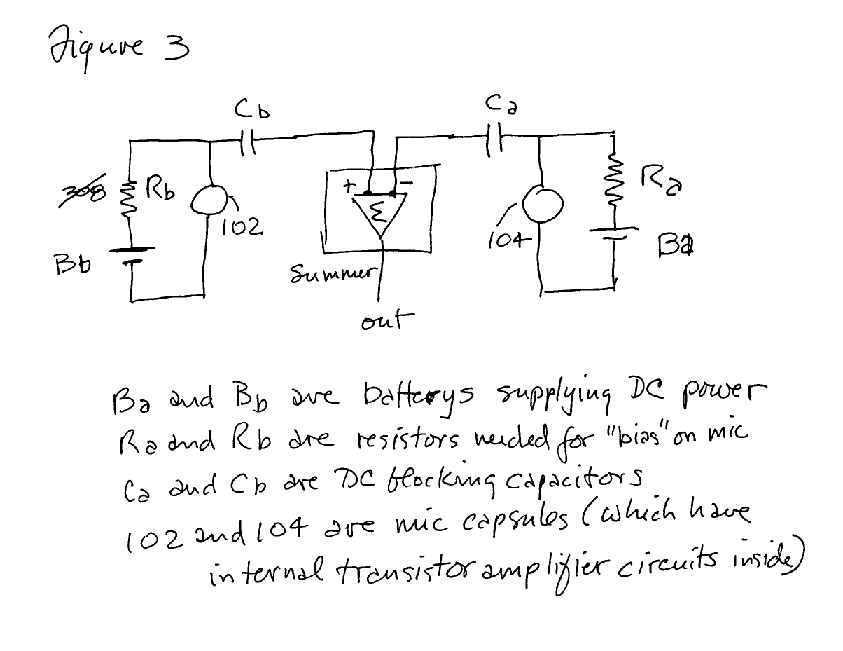

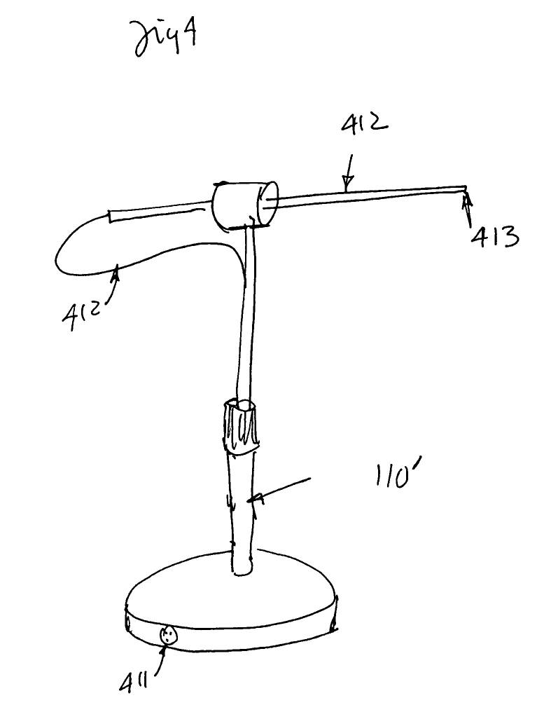

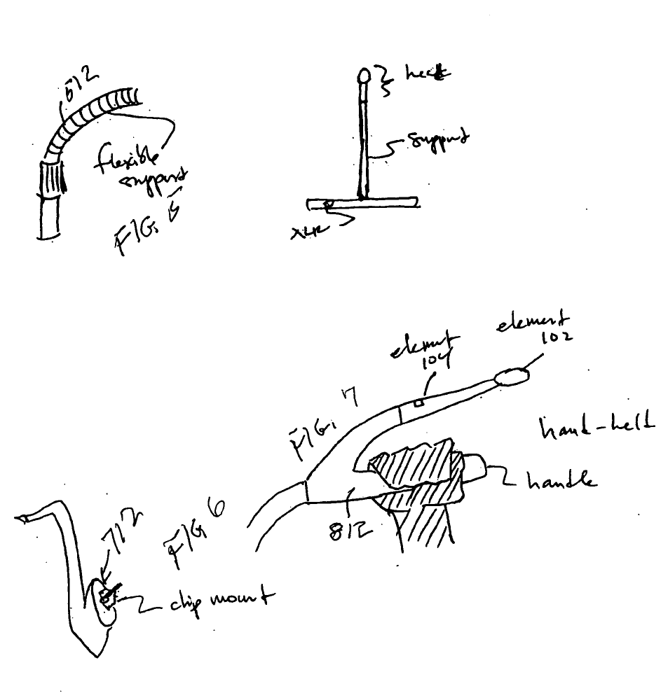

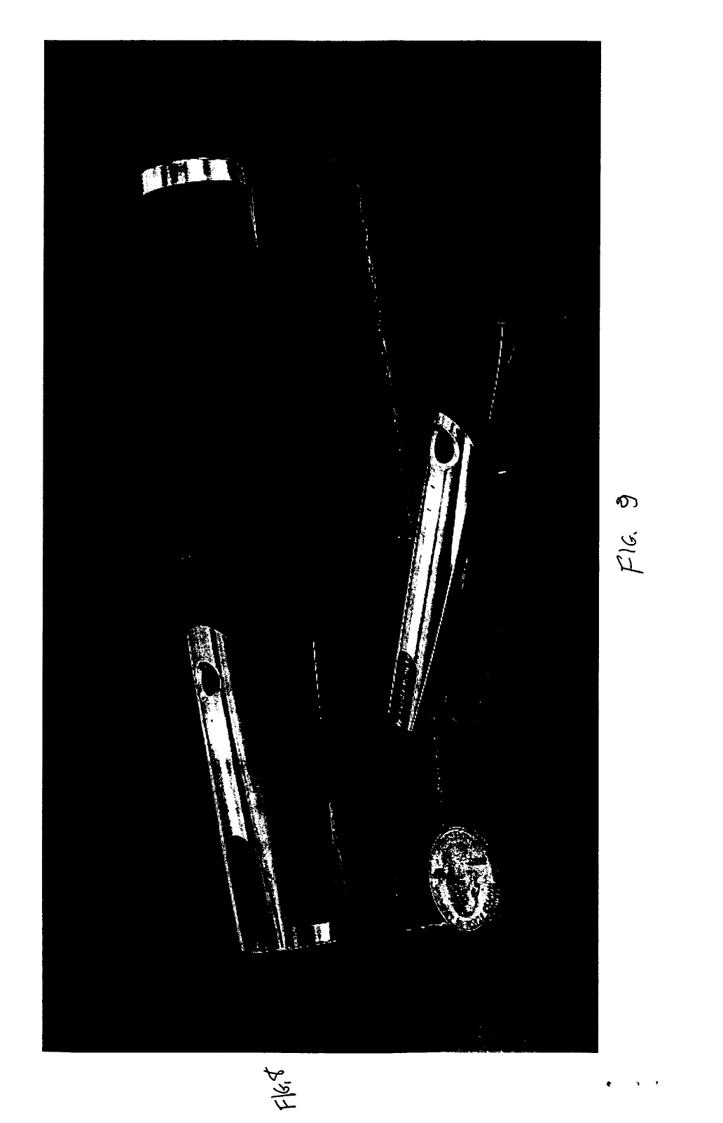

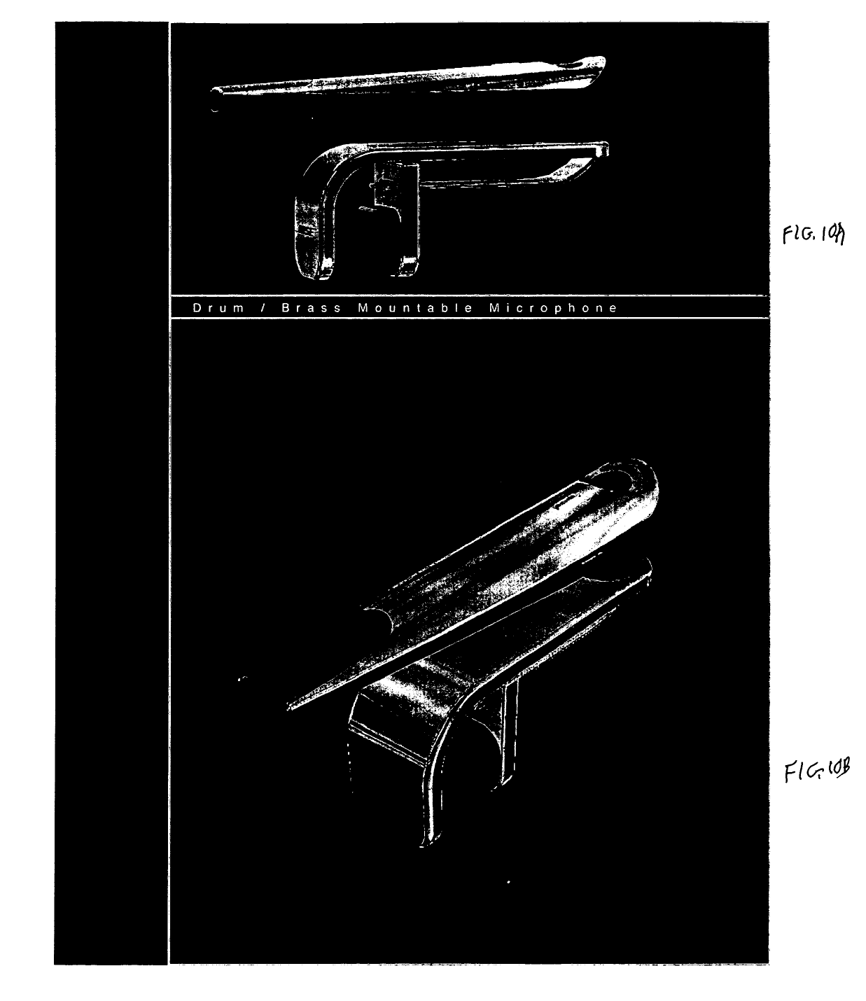

With reference now to the drawing and more particularly FIG. 1, there is shown a pictorial representation of an embodiment of the invention. The microphone 100 includes dual differentially-combined capsules 102 and 104 angularly and linearly displaced with capsule 102 along the axis of the cylindrical support 102 and capsule 104 perpendicular to this axis. The spacing between capsules 102 and 104 is typically 3.3 inch. A three-terminal jack 114 receives leads from capsules 102 and 104 and a common lead. Flexible extension 110 may also attach to a microphone stand, as shown in FIG. 5. A flexible extension of this type is typical of a head-worn “boom” or drummer's microphone.

Referring to FIG. 2, there is shown a schematic circuit diagram of a system including the embodiment of FIG. 1. The two leads from capsules 102 are connected to terminals 3 and 1 across resistor 308. Two leads from capsule 104 are connected to terminals 2 and 1 respectively across resistor 310. Batteries B1 and B2 furnish biasing potential to capsules 102 and 104 respectively through resistors R1 and R2 respectively. Capacitors C1 and C2 couple the outputs of capsules 102 and 104 respectively to the + and − inputs of differential combiner 312 whose output is coupled to the rest of the mixer (not shown).

Referring to FIG. 3, there is shown a schematic circuit diagram illustrating how outputs from capsules 102 and 104 are differentially combined. Bₐ and B_{b} are batteries supplying DC power; Rₐ and R_{b} are resistors furnishing bias to the capsules; Cₐ and C_{b} are DC blocking capacitors; and 102 and 104 are the capsules (which have internal transistor amplifier circuits inside).

Referring to FIG. 4, there is shown a suitable microphone stand including a base 410 having an XLR socket 411 carrying support 110′ that is extendable with a boom 412 having a three-pin socket 413 for receiving the microphone. Sockets 413 and 411 are electrically connected by wires running inside the microphone stand and boom.

Referring to FIG. 5, there is shown a variation of the embodiment of FIG. 4 having a flexible support 512 instead of boom 412.

Referring to FIG. 6, there is shown an embodiment with a clamp structure 712 supporting the microphone.

Referring to FIG. 7, there is shown a variation of a hand-held embodiment having a handle 812.

Referring to FIG. 8, there is shown a perspective view of an actual hand held embodiment of a microphone according to the invention;

Referring to FIG. 9, there is shown a perspective view of an actual stand-mount embodiment according to the invention.

Referring to FIGS. 10A and 10B, there are shown perspective views of an actual embodiment of the invention suitable for clamping to the rim of a drum or the bell of a wind instrument;

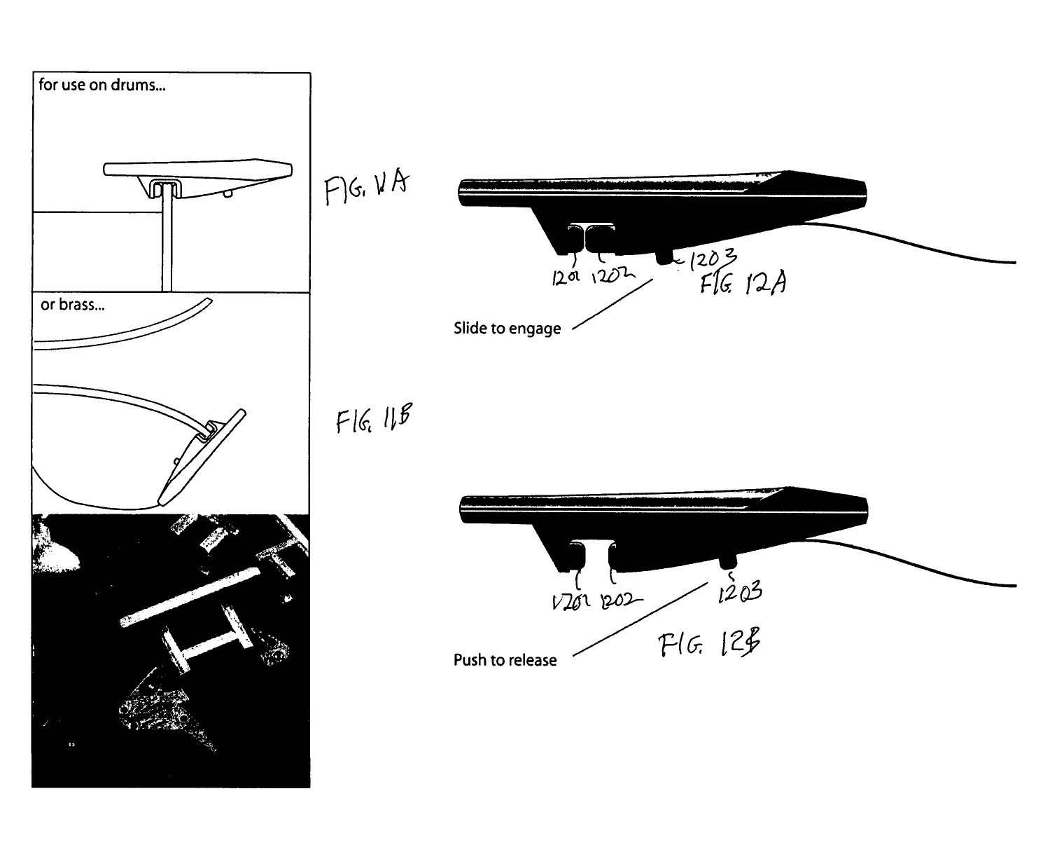

Referring to FIG. 11A, there is shown a pictorial view illustrating how the embodiment of FIGS. 12A and 12B may be clamped to the rim of a drum.

Referring to FIG. 11B, there is shown a pictorial view illustrating how the embodiment of FIGS. 12A and 12B may be clamped to the bell of a wind instrument.

Referring to FIG. 12A, there is shown a side view of a clamp mount embodiment of the invention with the jaws 1201 and 1202 closed when button 1203 is slid to the left.

Referring to FIG. 12B, there is shown a side view of the clamp mount embodiment of FIG. 12A with jaws 1201 and 1202 separated when button 1203 is slid to the right.

The clamp structure preferably includes a quick release feature and is adjustable so that it can attach a wide range of structures with adjustable clamping force and can accommodate a wide range of clamp widths with constant level of clamp force, if desired.

A specific clamp arrangement for a wind instrument may comprise having the primary microphone capsule, such as 102 constructed and arranged so that it is oriented in the bell of the instrument, such as a brass instrument, and the canceling capsule, such as 104, located outside the bell, away from the direct radiation path of the instrument. Stated in other words, the primary capsule is on the instrument axis, and the canceling capsule is off axis.

A system according to the invention includes a plurality of dual element differential microphones, used with a plurality of line arrays for a plurality of performers. Preferably, each microphone is oriented with the axis of the target capsule perpendicular to the line arrays.

A feature of an aspect of the invention resides in having the individual capsules angularly and linearly displaced. In a specific form the primary capsule is located in the head of the support structure with the auxiliary or canceling capsule located on the outer circumference of the support structure.

The housing structure is constructed and arranged to encourage the user to grasp the microphone away from the location of the canceling capsule, typically by having ridges or other structures. Preferably, the geometry is arranged so that it is difficult for a user to inadvertently cover the auxiliary canceling capsule. The structure may have a recess accommodating the canceling capsule to prevent covering completely.

Variable spacing between capsules may be affected with a flexible connection between the two capsules to allow for easy adjustment of the spacing between.

The microphone system according to the invention typically includes a head assembly, a system of utility fixtures to which the head is attached and structure connecting the head to the fixtures, both electrically and mechanically. The head assembly has two capsules, such as 102 and 104. In a specific form, these capsules are commercially available, Panasonic 60A92 electret elements typical of many small (4-8 mm) onmidirectional electret microphone capsules.

One element, such as 102, is the target element and the other, such as 104, is the canceling element. The target and canceling elements are linearly spaced from each other, typically 3.30″ (a three point 8 mm). The target element is fixed to the physical end or extremity of the head assembly. A two-stage pop or puff filter is typically assembled over the acoustical entrance to the target element. In a specific form this filter is a relatively close-fitting stainless steel resistive mesh cup and then a larger 100 PPI reticulated urethane foam pop-filter that fits over the target-element/mesh assembly. In a specific form, a simple, minimum-envelope, acoustically transparent grill fits over the canceling element, or both the target and canceling elements to conceal and protect both elements and to provide an esthetically pleasing appearance.

The two elements are wired out of phase as indicated above while still providing a phantom voltage (typically 48 or 24 VDC) to both in a specific form. In a specific form each element is wired to legs of a typical XLR connector.

Preferably the sensitivity of the first and second capsules is substantially the same. Matching can be achieved by sorting, varying the resistance of the biasing resistors, or other suitable means so that the ratio of electrical output to acoustic pressure input for both capsules is substantially the same.

Any means of providing DC bias, such as a battery or external supply and any means of providing a differential mixing circuit may be used within the principles of the invention.

Parallel dropping resistors furnish specific phantom voltages less than 48 or 24 VDC for both microphone elements. An acoustic signal, such as a human voice, that is close to the target element provides a transduced signal that is greater than that generated by the relatively distant canceling element and passes through the microphone system as the dominant target-generated signal. The far-field signals that arrive at both elements with substantially the same sound pressure level produce canceling transduced signals.

There has been described novel apparatus and techniques for microphoning. It is evident that those skilled in the art may now make numerous uses and modifications of and departures from the specific apparatus and techniques herein disclosed without departing from the inventive concepts. Consequently, the invention is to be construed as embracing each and every novel feature and novel combination of features present in or possessed by the apparatus and techniques herein disclosed and limited solely by the spirit and scope of the appended claims.

What is claimed is:

1. A microphone comprising,
first and second differentially interconnected capsules angularly and linearly displaced from each other by a predetermined amount.

2. A microphone in accordance with claim 1 and further comprising at least one puff filter associated with at least one of the capsules.

3. A microphone in accordance with claim 1 and further comprising,
support structure mounting the first and second capsules formed with openings exposing the capsules and constructed and arranged to allow handling by a user while inhibiting covering either of said openings.

4. A plurality of microphones in accordance with claim 1 and further comprising,
a corresponding plurality of amplifiers each associated with a respective one of the microphones,
and a plurality of line speakers each connected to a respective amplifier.

5. A microphone in accordance with claim 1 wherein said capsules are characterized by substantially the same sensitivity.

6. A microphone in accordance with claim 5 and further comprising a biasing resistor connected to one of said capsules establishing said substantially same sensitivity.

7. A microphone in accordance with claim 3 wherein said support structure includes a handle constructed and arranged to hide the connection between a microphone cable and the microphone.

8. A microphone in accordance with claim 1 wherein said capsules are wired in phase opposition.

9. A microphone in accordance with claim 8 and further comprising an XLR connector having three legs,
each of said capsules wired to a pair of said legs,
and a parallel dropping resistor furnishing biasing potential.

10. A microphone in accordance with claim 9 and further comprising a mixer with a balanced input preamplifier having first and second inputs respectively coupled to said first and second capsules.

11. A microphone in accordance with claim 1 and further comprising support structure mounting the first and second capsules having a clamp mechanism.

12. A microphone in accordance with claim 11 and further comprising a musical instrument having a rim, said clamp mechanism engaging said rim.

13. Apparatus in accordance with claim 12 wherein said rim is the rim of a drum.

14. Apparatus in accordance with claim 12 wherein said rim is the bell of a wind instrument.

15. A microphone in accordance with claim 1 wherein said microphone is constructed and arranged to allow for the spacing between said first and second capsules to be adjusted.

16. A microphone in accordance with claim 15 wherein the connection between said first and second capsules is flexible to allow for the spacing between said first and second capsules to be adjusted.

17. A microphone in accordance with claim 1 wherein said angle is substantially a right angle.

18. A microphone in accordance with claim 1 wherein the separation between said first and second capsules is within the range of ½″ to 5″.

19. A microphone in accordance with claim 18 wherein said separation is substantially 3.3″.

20. A microphone in accordance with claim 3 wherein said first capsule is at an end of said support structure and said second capsule is inside said support structure spaced from said end.
